(19) United States
(12) Patent Application Publication
(10) Pub. No.: US 2017/0293989 A1
(43) Pub. Date: Oct. 12, 2017

(54) AUTOMATED PAROLE, PROBATION, AND COMMUNITY SUPERVISION SYSTEM

(71) Applicant: Global Tel*Link Corporation, Reston, VA (US)

(72) Inventor: Stephen Lee Hodge, Aubrey, TX (US)

(21) Appl. No.: 15/095,303

(22) Filed: Apr. 11, 2016

(51) Int. Cl. G06Q 50/26; G06F 17/30; H04L 29/06

(52) U.S. Cl. CPC G06Q 50/26; H04L 63/0861; H04L 63/083; G06F 17/30241; G06F 17/3056; G06F 17/3087

(57) ABSTRACT

A system and method of automated supervision and monitoring of offenders who have been paroled from a correctional facility or placed on probation. The system allows offenders to remotely report to their designated parole officer, enabling a convenient and efficient method of ensuring that the offenders are following the terms of their parole through an automated procedure. The system tracks and monitors an offender's movements to ensure they stay within a certain area. The system receives the offender's location information and processes the location information to determine whether the offender stayed within a certain area. The system is also equipped with interfaces to testing systems to administer remote substance abuse monitoring. Community service is another important function that is monitored by the system. The community service requirement for an offender varies depending on the court order. The system reports to the parole office regarding any indication of parole condition violations throughout the automated report by the offender.

### BACKGROUND

### Field

The disclosure relates to a system and method of an automated supervision and monitoring system used to monitor offenders who have been paroled from a correctional facility, placed on probation or assigned community supervision by the courts.

### Related Art

Offenders released from correctional facilities are normally placed under probation and parole programs. Probation and parole programs are considered community corrections and involve offender supervision in the community. Accordingly, offenders are assigned to parole officers who are responsible for the monitoring and reporting of the offenders. Offenders are required to regularly report to their designated officer. During these reports, officers ensure that the offenders are following the terms of their parole. These terms include finding employment, not breaking any laws, abstaining from alcohol and drugs, and keeping scheduled meetings with the officer. Additionally, officers are frequently expected to make periodic visits to places of residence for many offenders.

### BRIEF DESCRIPTION OF THE DRAWINGS/FIGURES

Embodiments are described with reference to the accompanying drawings. In the drawings, like reference numbers indicate identical or functionally similar elements. Additionally, the left most digit(s) of a reference number identifies the drawing in which the reference number first appears.

FIG. 1 illustrates an automated parole, probation, and community supervision system, according to an embodiment of the invention.

FIG. 2 illustrates a block diagram of an automated parole, probation, and community supervision system, according to an embodiment of the invention.

FIG. 3 illustrates a block diagram of a kiosk, according to an embodiment of the invention.

FIG. 4 illustrates a flowchart diagram of a method of enrollment to the automated parole, probation, and community supervision system, according to an embodiment of the invention.

FIG. 5 illustrates a flowchart diagram of a method of the automated reporting procedure of the automated parole, probation, and community supervision system, according to an embodiment of the invention.

FIG. 6 illustrates a flowchart diagram of a method of automated reporting procedure of the automated parole, probation, and community supervision system in regards to offender case specific information, according to an embodiment of the invention.

FIG. 7 illustrates a block diagram of a general purpose computer that may be used to perform various aspects of the present disclosure.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

Embodiments may be implemented in hardware (e.g., circuits), firmware, computer instructions, or any combination thereof. Embodiments may be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices, or other hardware devices Further, firmware, routines, computer instructions may be described herein as performing certain actions. However, it should be appreciated that such descriptions are merely for convenience and that such actions in fact results from computing devices, processors, controllers, or other devices executing the firmware, routines, instructions, etc. Further, any of the implementation variations may be carried out by a general purpose computer, as described below.

For purposes of this discussion, the term “module” shall be understood to include at least one of hardware (such as one or more circuit, microchip, processor, or device, or any combination thereof), firmware, computer instructions, and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Historically, offenders released from correctional facilities have been placed under parole and probation programs in which they are required to report to assigned parole officers who are responsible for the monitoring and reporting of the offenders. These parole and probation programs are designed to enhance public safety as well as improve the recidivism rates of offenders. The programs are tailored to increase an offender's accountability, provide restitution to the victim, provide rehabilitative needs for the offender, reduce the cost of punishment, and ensure that the scarce and costly prison cells are reserved for those from whom the public needs protection. The programs also provide jurisdictions with an alternative sentencing program to ease overcrowding of incarceration facilities. Mainly, the parole and probation programs are focused on the efficient management of released offenders within the community.

Such parole and probation programs can also be used to manage qualified pretrial offenders. If the pretrial offenders are unable to post bail and are considered nonviolent, the programs can be used to supervise and monitor the accused offender rather than incarcerating them. The programs allow the management of nonviolent adult and many juvenile offenders. The programs decrease the rates of recidivism and lower the cost of punishment. Additionally, the use of the programs foster early release programs.

The probation and parole programs provide a very high level of supervision including the monitoring of the offender, the enforcement of ordered probationary conditions, and the opportunity of self-improvement and rehabilitation. Offenders are usually required to make periodic visits to jurisdiction offices to report to their designated parole officer. Having an offender make periodic visits to jurisdiction offices serves several purposes. The visits demonstrate the offender's ability to keep schedule, determine the location of the parolee, allow the officer to observe the look and demeanor of the offender, and allow for an opportunity for the offender to be tested for substance abuse. Most visits end with arranging a follow up appointment.

Unfortunately, the lack of necessary resources in certain jurisdictions and the overwhelming number of cases dedicated to a parole officer places a heavy burden on them and negatively impacts the efficiency of the current supervision and monitoring system. At times, officers may have a case load of as many as several hundred cases. Accordingly, the current system of officers personally supervising and monitoring paroled offenders presents a number of challenges that are not sufficiently supported for efficient supervision and monitoring.

With these concerns in mind, it is preferable to implement automated services in the current supervision and monitoring system for use by law enforcement personnel who are responsible for the monitoring and reporting of offenders that have been paroled from a correctional facility, placed on probation, or ordered by a court to a support group, community support, or community service. With this objective in mind, the following description is provided for an advanced automated parole, probation, and community supervision system.

### Exemplary Automated Parole, Probation, and Community Supervision System Environment

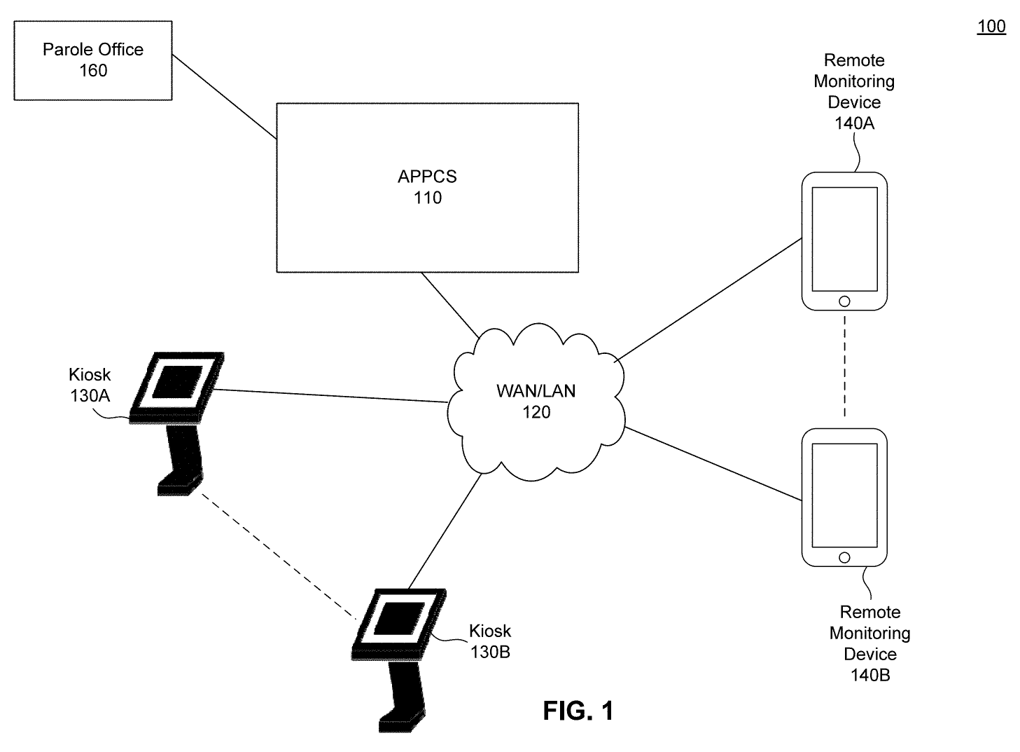

FIG. 1 illustrates an exemplary automated parole, probation, and community supervision system environment 100. In the environment 100, an automated parole, probation, and communication supervision system (“APPCS”) 110 is connected to a parole office 160, one or more kiosks 130A-B, and one or more remote monitoring devices 140A-B. The APPCS 110 is connected through WAN/LAN 120 to the one or more kiosks 130A-B and remote monitoring devices 140A-B.

In an embodiment, the APPCS 110 performs a variety of functions with respect to supervising and monitoring offenders that have been paroled from a correctional facility or placed on probation. The APPCS 110 allows the remote interaction between a parole office 160 and an offender via one or more kiosks 130A-B. Accordingly, the APPCS 110 allows offenders to remotely report to their designated parole officer, which enables a convenient and efficient method of ensuring that the offenders are following the terms of their parole. The APPCS 110 tracks and monitors an offender's movements to ensure they stay within a certain area through one or more remote monitoring devices 140A-B. The APPCS 110 receives the offender's location information from the one or more remote monitoring devices and processes the location information to determine whether the offender stayed within a certain area. The APPCS 110 alerts the parole office 160 if there is a court order violation. The APPCS 110 is also equipped with interfaces to testing systems to administer remote substance abuse monitoring. The APPCS 110 reports any indication of substance abuse in violation of a case order to the parole office 160. Community service is another important function that is monitored by the APPCS 110. The community service requirement for an offender varies depending on the court order. Examples of community service requirements may include the payment of administrative fees, a set number of community service hours of work performed per day/week/month, monthly reports of community service progress, and adherence to special program placements as ordered.

In an embodiment, the APPCS 110 is configured to communicate with one or more kiosks 130A-B in order to conduct an automated report. The kiosks 130A-B are utilized for automated reports when a personal interaction between an offender and a parole officer is not required. The kiosks 130A-B provide a method of monitoring offenders deemed appropriate based on their risk to public safety and an assessment of the offenders' needs. In another embodiment, the kiosks 130A-B are used to enhance personal supervision through augmentation of the kiosks 130A-B and personal interviews. For example, probation can be intensified by requiring frequent in-person visits to the probation officer as well as additional reporting visits made through the kiosks 130A-B.

The kiosks 130A-B implement a fully automated reporting system where an offender who has been enrolled in the system can complete a routine interview which would be later reported to their designated parole officer. The use of kiosks 130A-B for automated remote reporting improves the accountability of the offender and also enhances the efficiency of the monitoring system. In order to access the kiosks 130A-B, the offender's identity is determined by standard login procedures accompanied with verification of biometric information scans. Once the APPCS 110 verifies the offender and allows access to the kiosk 130A-B, the offender is prompted to input general information along with information specific to his or her parole and probation status. The input information may be regarding judicially ordered special conditions such as drug testing and substance abuse monitoring, community service requirements, demographic changes, and reporting frequency, among others. In an embodiment, the kiosk 130A-B is configured to retrieve the offender's remote monitoring information by accessing the offender's remote monitoring device 140A-B connected through WAN/LAN 120. The kiosk 130A-B temporarily stores the input information in a database and transmits the information to the APPCS 110. Upon the detection of a parole condition violation, the APPCS 110 connects the offender through the kiosk 130A-B to his or her designated parole officer to conduct a remote video reporting session.

The APPCS 110 is configured to monitor an offender's movements to ensure they stay within a certain area through one or more remote monitoring devices 140A-B, according to an embodiment of the invention. The APPCS 110 tracks the movements of an offender through the GPS installed in the remote monitoring devices 140A-B. The APPCS 110 periodically checks on the current location of the offender to determine whether the offender is in a location restricted by the parole terms. The APPCS 110 receives the offender's location information from the one or more remote monitoring devices 140A-B and processes the location information to determine the offender's location. The APPCS 110 alerts the parole office if the system determines that the offender's movements indicate a violation of the parole terms. In another embodiment, the APPCS 110 allows the parole office to place calls to an offender's remote monitoring device or receive reports from the offender via the remote monitoring devices 140A-B. The offender may be required to access a private network at a designated location in order to report to the parole office using the remote monitoring device. For example, a private network is set up at the offender's home and the offender may place a call to the parole office only when the remote monitoring device 140A-B is connected to the private network. The remote monitoring device 140A-B is used for the parole office 160 to make random calls to the offender at unscheduled times and to receive reports from the offender at scheduled times. In another embodiment, the remote monitoring devices 140A-B include smart phones, wireless communication devices, wearable devices, home installed device, stamps, and implants, among others.

### Exemplary Automated Parole, Probation, and Community Supervision System

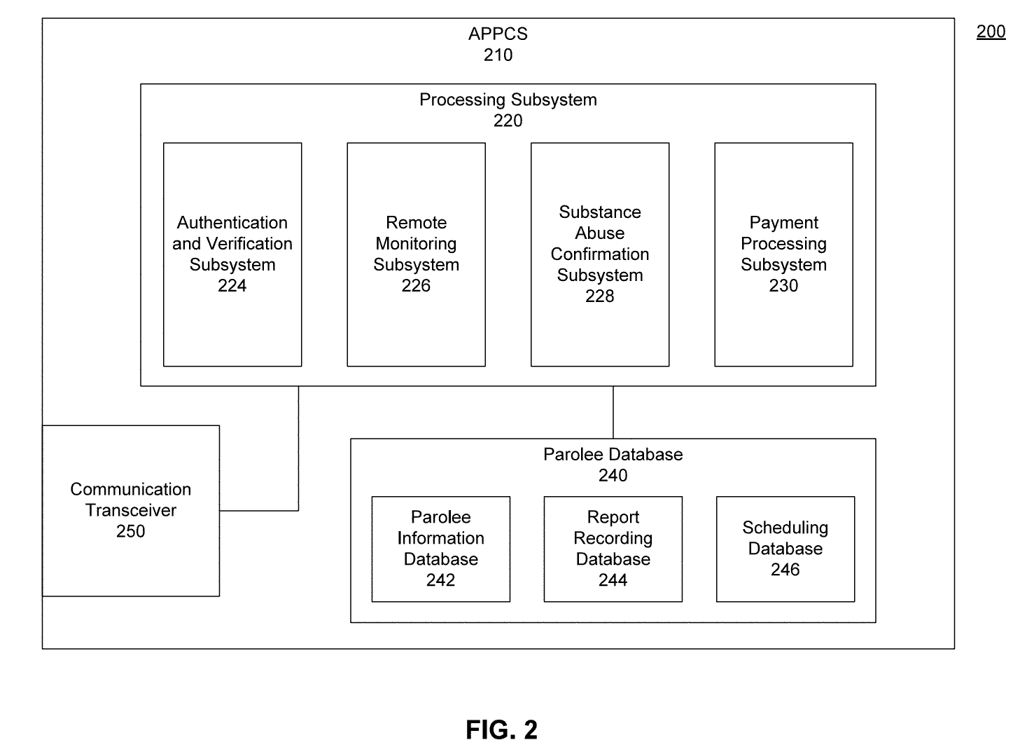

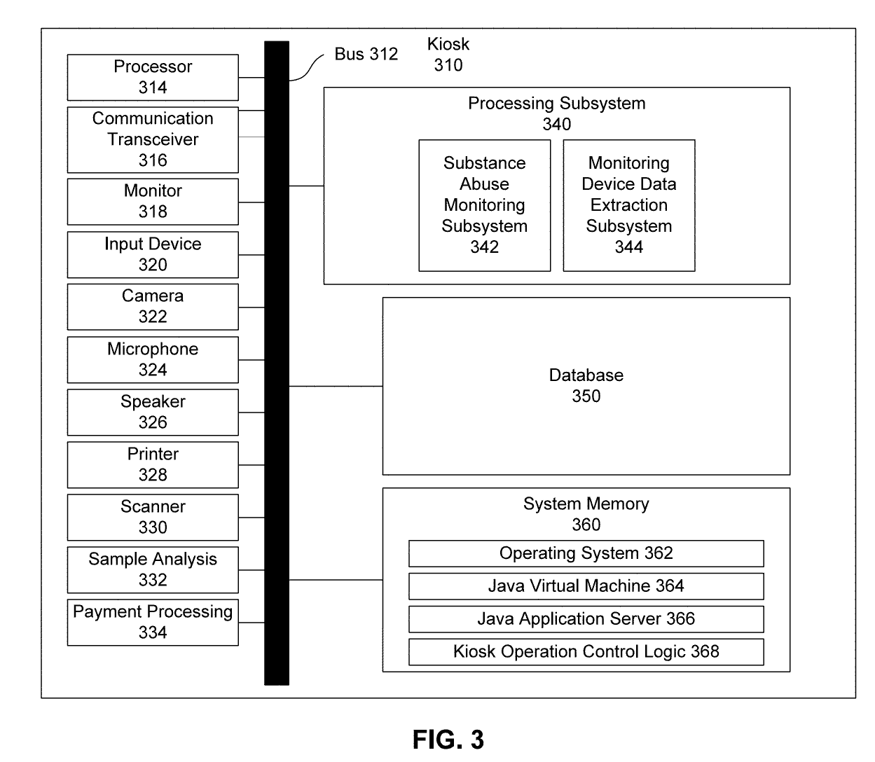

FIG. 2 illustrates a block diagram of an automated parole, probation, and community supervision system (“APPCS”) 210, according to an embodiment of the invention. The APPCS 210 includes at least a processing subsystem 220, a parolee database 240, and a communication transceiver 250, and may represent an exemplary embodiment of the APPCS 110 illustrated in FIG. 1. The processing subsystem 220 includes an authentication and verification subsystem 224, a remote monitoring subsystem 226, a substance abuse monitoring subsystem 228, and a payment processing subsystem 230. The parolee database 240 includes a parolee information database 242, a report recording database 244, and a scheduling database 246. For ease of understanding, descriptions of FIG. 2 may refer to FIGS. 1 and 3.

The communication transceiver 250 is used for the input and output processes of communication for the APPCS 210, according to an embodiment of the invention. The communication transceiver 250 allows two-way video, audio, and data communication between the kiosks 130A-B and the APPCS 210. The communication transceiver 250 is also capable of routing video, audio and data communication between the kiosks 130A-B and the parole office 160. In an embodiment, the communication transceiver 250 allows two-way video, audio, and data communication between the remote monitoring devices 140A-B and the APPCS 210.

When an offender accesses a kiosk 130A-B and inputs his or her access information through the input device of the designated kiosk 130A-B, the access information is transmitted to the APPCS 210 for verification by the authentication and verification subsystem 224. The authentication and verification subsystem 224 performs authentication and verification techniques to identify the offender and grant access to the kiosk 130A-B in order to conduct an automated report, according to an embodiment of the invention. Upon the receipt of the offender's access information, such as a photo identification and previously-assigned PIN (personal identification number), the authentication and verification subsystem 224 matches the provided identification information of the offender with an offender's parolee profile in the parolee information database 242.

In an embodiment, for further verification of the offender, the authentication and verification subsystem 224 is configured to acquire instantaneous authentication information, such as biometric information. The offender's biometric information is received by the kiosk 130A-B and transmitted to the APPCS 210. For example, the kiosk 130A-B may include one or more scanners 330, such as a fingerprint reader for capturing fingerprint data, camera 322 for capturing facial information, stereoscopic camera for capturing 3-dimensional image data, infrared camera for capturing heat signature data, signature pad for capturing a signature of the offender, microphone 324 for capturing voice information, among others. In an embodiment, the authentication and verification subsystem 224 conducts voice recognition in order to further enforce the authentication process. The authentication and verification subsystem 224 analyzes the voice information of the offender spoken through the microphone 324 attached to the kiosk 130A-B. The authentication and verification subsystem 224 recognizes phonemes and/or intonations that identify the offender's speech. The resulting voice pattern is associated with the offender and compared with the offender's voice pattern saved in the parolee information database 242. Similarly, in order to perform the additional verification, the authentication and verification subsystem 224 compares the captured biometric information to the stored biometric information in the parolee information database 242 and determines whether they match to a predetermined degree. If the captured biometric information does not match to a predetermined degree, the parole office 160 is alerted and the offender is denied access to the automated report.

Once the APPCS 210 determines that the offender has provided the proper access information and has been verified by the authentication and verification subsystem 224, the APPCS 210 facilitates the automated report by prompting the offender to answer automated reporting questions showed on the monitor 318 of the kiosk 310. All answers submitted by the offender is transmitted to the APPCS 210. Based on the answers submitted by the offender through the input device of the kiosk 130A-B, the APPCS 210 determines which subsystem 224-230 within the processing subsystem would be appropriate for the further analysis of the received information. For example, if the offender submits information regarding the offender's recent previous locations and the violation of his or her geo-fencing status, the APPCS 210 receives this information through the communication transceiver 250 and processes this information at the remote monitoring subsystem 226. If at any time the APPCS 210 detects a parole condition violation during the offender's automated report, the APPCS 210 alerts the parole office and initiates a video report session between the offender and the parole office 160 to address the parole condition violation.

The remote monitoring subsystem 226 determines the location and status of an offender based on the location and status information transmitted by the offender's remote monitoring device 140A-B, according to an embodiment of the invention. An offender whose parole terms state that he or she stay within a restricted area may have to carry remote monitoring devices 140A-B. The remote monitoring devices 140A-B tracks the movements and periodic locations of the offender throughout an extended period of time. This location and status information of the offender stored in the remote monitoring devices 140A-B is transmitted to the remote monitoring subsystem directly by the remote monitoring devices 140A-B. In an embodiment, the kiosk 130A-B is configured to extract the location and status information from the remote monitoring devices 140A-B and transmit the information to the remote monitoring subsystem 226. The location and status information includes GPS location information, photos, records, and voice samples, among others. The remote monitoring subsystem 226 acquires a geographic limitations map reflecting the restricted area that an offender must stay within according to the offender's parole conditions. This geographic limitations map is stored with the offender's parolee information in the parolee information database 242. Using the location and status information, the remote monitoring subsystem 226 compares the data of the location information to that map. For each of the data points in the location information, the remote monitoring subsystem 226 determines whether they are within or outside of the geographic limitations maps. If all are inside, then the APPCS 210 determines that there is no violation of the parole conditions. In an embodiment, the location and status information is retrieved from the remote monitoring device 140A-B by a designated kiosk and transmitted to the remote monitoring subsystem 226.

The substance abuse confirmation subsystem 228 monitors for substance abuse by the offender, according to an embodiment of the invention. Offenders with parole conditions restricting substance abuse may be required to submit a biological specimen during the automated report at the kiosk 310. The kiosk is configured to acquire biological specimen from the offender through the sample analysis 332 of the kiosk 310. The substance abuse monitoring process of the automated report is conducted in two steps. The first step is the screening test and is conducted at the kiosk 310. The acquired biological specimen is analyzed and processed to detect substance abuse. The resulting data of the analysis is stored as biological specimen data for further analysis. If the initial screening test at the kiosk 310 turns out to be negative, the biological specimen data is transmitted to the substance abuse confirmation subsystem 228 of the APPCS 210 to match the DNA of the submitted biological specimen with the DNA of the offender saved in the parolee database 242 in order to confirm that the biological specimen was provided by the offender. If the screening test at the kiosk 310 is positive, the biological specimen data is transmitted to the substance abuse confirmation subsystem 228 of the APPCS 210 to conduct a confirmation test. Upon receipt of the biological specimen data, a confirmation testing of the substance abuse is conducted. This in-depth analysis does not necessarily have to be conducted in real time. The duration of the analysis depends on the type of substance being analyzed. The result of the in-depth substance abuse analysis, including any parole condition violations, can be reported to the parole office and the offender at a later time. In another embodiment, in order to verify that the biological specimen data is actually the offender's biological specimen, a DNA test is run on the received biological specimen and the substance abuse confirmation subsystem 228 determines whether the DNA matches the DNA for the offender in the parolee database 242. In another embodiment, upon a positive determination at the kiosk 310, the parole office 160 is notified by the APPCS 110 and a video conference between the offender and the parole office 160 is initiated.

The payment processing subsystem 230 processes the payments made by the offenders during an automated report, according to an embodiment of the invention. The parole conditions for community service for an offender consists of payment of administrative fees, fines and restitution to the victims, among others. During an automated report, offenders may be required to make such payments at the kiosk 310. Accordingly, the payments can be made through the payment processing 334 of the kiosk 310. The payment processing 334 of the kiosk 310 is configured to take the form of a card reader, cash depository, cash dispenser, among others and payments may be made with credit cards, debit cards, cash, and checks, among others. When a payment is made by an offender at the kiosk 310, the payment transaction data is transmitted with the payment notification and processed at the payment processing subsystem 230. The payment of such fees are acknowledged and saved in the parolee information database 242 by the APPCS 210. Reports of the payment is provided to the parole office 160 and a receipt for the payment is printed for the offender at the end of the automated report.

The parolee database 240 contains all current detailed information regarding the offenders, according to an embodiment of the invention. The parolee information database 242 stores the personal and authentication information of the parolee including personal identification numbers, biometric information, current address, contact information, parolee report history, digital photos of the offenders, fingerprints, handprints, medical information, substance abuse history, community service requirements, any specific case order regarding the conditions of parole, and scheduling information for previous and future reports to the parole office, among others. Examples of community requirements include the payment of administrative fees, a set number of community service hours of works required of the offender, monthly reporting of community service progress, and adherence to special program placements as ordered by the court, among others. Examples of specific case orders include the monitoring of substance abuse and remote location monitoring, among others.

The report recording database 244 stores the recordings of an offender's automated report, according to an embodiment of the invention. There are many reasons to store such information, primarily monitoring. A camera 322 installed on the kiosk 310 is configured to record the offender during the automated report and the recordings would be transmitted to the APPCS 210 and stored in the report recording database 244. Additionally, any video conference between the offender and the parole office may be recorded and stored in the report recording database 244. In an embodiment, because video and audio files consume significant amounts of storage space, this data is preferably stored on a Network Attached Storage (NAS) device configured as a mass storage device. The report recording database 244 may include links and/or pointers to recording data located on the NAS device. In order to reduce the required size of the NAS device, the NAS device preferably includes a backup routine to transfer recording data to permanent storage devices, such as archival permanent storage or optical disks, after a predetermined time has elapsed since the initial recording of that data.

The scheduling database 246 stores scheduled automated reports that have not yet occurred as well as previous automated report information (e.g., automated report session records), according to an embodiment of the invention. In this regard, the scheduling database 246 stores a calendar of scheduled automated reports, as well as information relating to those automated reports, such as the offender to be involved, the offender's personal identification number, their contact information, case specific court orders, and parole conditions relevant to the offender.

### Exemplary Kiosk

FIG. 3. illustrates a block diagram of a kiosk 310, according to an embodiment of the invention. The kiosk 310 includes at least a processing subsystem 340, a database 350, a system memory 360, and a plurality of peripherals 314-334 and may represent an exemplary embodiment of a kiosk 130A-B illustrated in FIG. 1. The processing subsystem 340 includes a substance abuse monitoring subsystem 342 and a monitoring device data extraction subsystem 344. The database 350 temporarily stores all information submitted by the offender during an automated report before it is transmitted to the APPCS 210. The system memory 360 contains the runtime environment of the kiosk, storing temporary data for any of the operating system 362, java virtual machine 364, java application server 366, and kiosk operation control logic 368. The system memory 360 is preferably faster and more efficient than the database 350, and is configured as random access memory (RAM) in an embodiment.

The kiosk 310 includes one or more processors 314 for implementing subsystems within the processing subsystem 340. A subsystem in the processing subsystem 340 is configured to include a selection of stored operations that when executing in the one or more processors 314 causes the one or more processors 314 to perform the operations of the subsystem. In an embodiment, the one or more processers 314 are connected via a bus 312 to several other peripherals. Such peripherals include a communication transceiver 316 that provides network connectivity and communication, a monitor 318 for displaying information, an input device 320, such as a keyboard and/or a mouse, a camera 322 for taking pictures and/or video reporting sessions, a microphone 324, a speaker 326, a printer 328 to print confirmation documents and/or receipts, a scanner 330 to scan fingerprints, handprints, and/or any relevant documents, a sample analysis 332 to collect biological specimen from the offender to monitor substance abuse, and payment processing 334 to process payments made by the offender.

The kiosk 310 implements a fully automated reporting system and provides a platform through the multiple peripherals 316-334 that allows offenders to conduct an automated report to the parole office. The kiosk 310 is configured to facilitate the automated report to be submitted to a centralized APPCS 210. In another embodiment, the kiosk 310 is configured to be a localized APPCS 210 and contain all of the functions of the APPCS 210.

The substance abuse monitoring subsystem 342 performs technical analysis of biological specimen of the offender to ensure that the offenders have not violated substance abuse orders, according to an embodiment of the invention. If the offender's parole condition includes substance abuse monitoring, the substance abuse monitoring subsystem 342 offender is required to submit biological specimen through the sample analysis 332 of the kiosk 310. The sample analysis 332 of the kiosk may take the form of a breathalyzer, urine depository, hair depository, sweat pad depository, among others. Upon receipt of the biological specimen from the offender, the substance abuse monitoring subsystem 342 performs an initial screening test on the biological specimen. The technical analysis of the biological specimen, such as urine, hair, blood, breath, sweat, or oral fluid, determines the presence or absence of alcohol or drugs. For example, a breath test utilizing a breathalyzer is a method for determining alcohol intoxication. The substance abuse monitoring subsystem 342 measures the alcohol content of the offender through their breath. Another example is a sweat drug test where offenders attach sweat patches to their skin for an extended period of time. The offender submits the sweat patches through the sample analysis 332. The sweat patches collects the sweat of the offender over the extended period of time and the substance abuse monitoring subsystem 342 measures whether or not a prohibited drug or alcohol is contained in the sweat. Upon a determination of substance abuse by the substance abuse monitoring subsystem 342, the result of the screening test and the biological specimen data is transmitted to the APPCS 210 for further analysis.

Some offenders who are required to make automated reports carry remote monitoring devices. In an embodiment of the invention, offenders are required to transmit the location information saved in the remote monitoring device during the automated report. The location information includes GPS location information, photos, records, and voice samples, among others. The monitoring device data extraction subsystem 344 of the kiosk 310 extracts the remote monitoring information contained in the offender's remote monitoring device 140A-B, according to an embodiment of the invention. The monitoring device data extraction subsystem 344 establishes a connection with remote monitoring device 140A-B and extracts all location information contained in the remote monitoring device 140A-B. The extracted information is temporarily stored in the database 350 and transmitted to the remote monitoring subsystem 226 of the APPCS 210 for determination of parole condition violation.

### System Operation

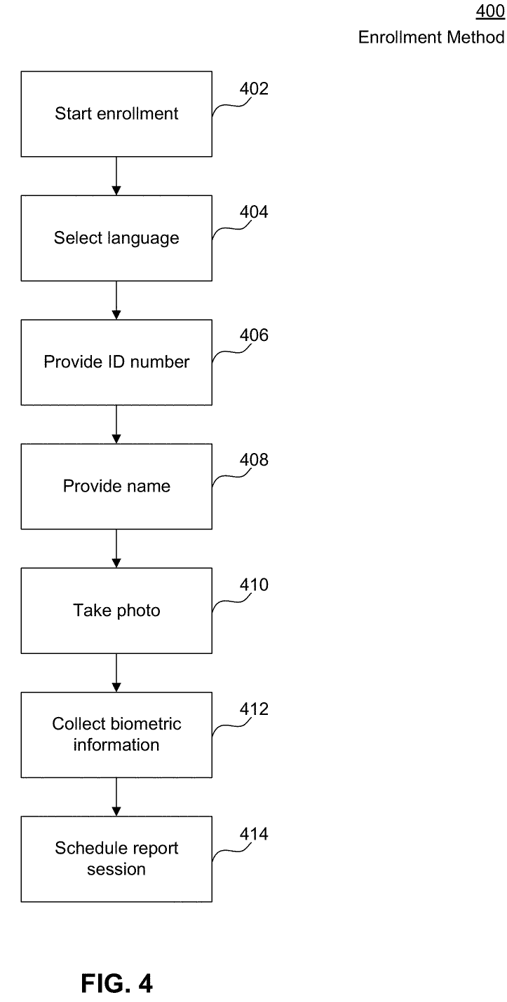

The operation of the system will be first described in FIG. 4, which illustrates a flowchart diagram of an exemplary method 400 for enrollment in the automated parole, probation, and community supervision system. The method of FIG. 4 is described below with reference to FIGS. 2 and 3.

The enrollment process is facilitated by a kiosk 310, as part of the APPCS 210. The offender is asked a series of questions displayed on the kiosk 310. At the outset, the offender approaches a kiosk and selects the enrollment process (402). The offender selects the language for the enrollment process (404) and provides his or her personal identification number (406). The offender continues to provide his or her name (408) and a photo of the offender is taken by the camera 322. Next, the offender is asked to provide biometric information (412). Biometric information provided by the offender includes finger prints, hand prints, voice biometrics, iris scan, photographs, facial architecture, hand geometry, signature identification, infrared camera identification, and any other biometric as deemed appropriate. Such biometric information is received by the input device 320, camera 322, microphone 324, scanner, and sample analysis 332, among others of the kiosk 310. All of the information provided by the offender in steps 402-412 is saved in the parolee information database 242.

To conclude the enrollment process, the offender is prompted to schedule the next report session (414). For the scheduling step, an appointment calendar shows on the monitor 318 showing a 5 day span for the next reporting session. After a day is selected by the offender, the available time slots of the selected day is displayed. The schedule information for the offender is saved in the scheduling database 246. Once the offender schedules the next report session, the enrollment process is concluded and the printer 328 prints a receipt with a summary of the enrollment process and the next appointment date and time.

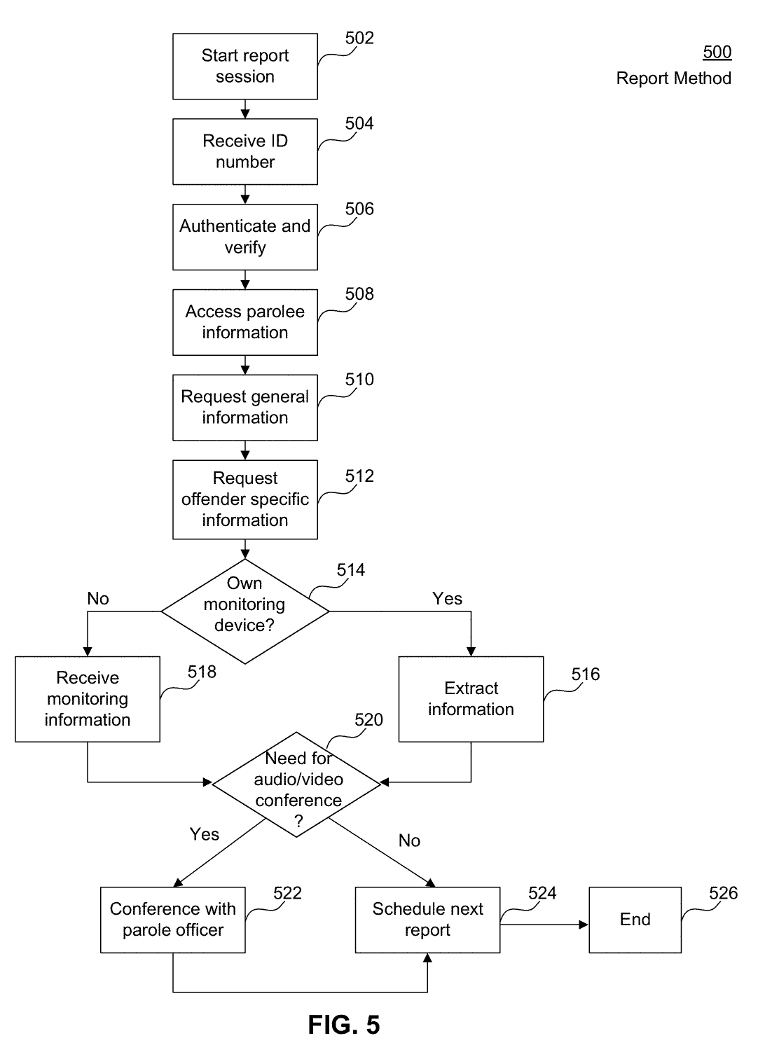

FIG. 5. illustrates a flowchart diagram of a method 500 for an automated reporting procedure. The method of FIG. 5. is described below with reference to FIGS. 2 and 3.

The kiosk 310, as a part of the APPCS 210, implements a fully automated reporting system where an offender who has been enrolled in the system can complete a routine interview which would be later reported to their designated parole officer. At any time during the automated reporting process, the parole office may initiate a remote video conference at any time during the automated reporting process to address any concerns in regards to the information submitted by the offender.

The automated reporting process is facilitated by a kiosk 310. The offender is asked a series of questions displayed on the kiosk 310. At the outset, the offender approaches a kiosk and selects the automated reporting process (502). The system then receives the personal identification number of the offender (504). Upon receipt of the identification number, the authentication and verification subsystem 224 performs authentication and verification to ensure that the offender is who he or she claims to be (506). The authentication and verification process may require the submission of the offender's biometric information. For example the kiosk 310 may include one or more scanners 330, such as a fingerprint reader for capturing fingerprint data, camera 322 for capturing facial information, stereoscopic camera for capturing 3-dimensional image data, infrared camera for capturing heat signature data, signature pad for capturing a signature of the offender, microphone 324 for capturing voice information, among others. The authentication and verification subsystem 224 can be configured for any of these types of authentication information. For example, authentication can be performed based on facial architecture in the case of 3D images, or based on signature analysis, etc. If the offender fails a predetermined number of attempts to authenticate themselves, the designated parole officer is immediately notified.

Once the offender is verified, the system accesses the offender's parole information (508) stored in the parolee database 240. The parolee information includes all current information regarding the offender. The current information contains personal identification number, current address, biometric information, digital photos of the offenders, fingerprints, handprints, medical information, substance abuse history, community service requirements, any specific case order regarding the conditions of parole, and scheduling information for previous and future reports to the parole office, among others.

Next, the system requests and receives general information from the offender (510). For example, the offender may be asked if they had been arrested since the incident related to this session, whether they had changed addresses, to provide current address and contact information, to provide employment information, among others. If any of the information provided by the offender violates a court order or does not match with the information stored in the parolee database 240, the parole office is notified and a video conference is initiated if deemed necessary by the system.

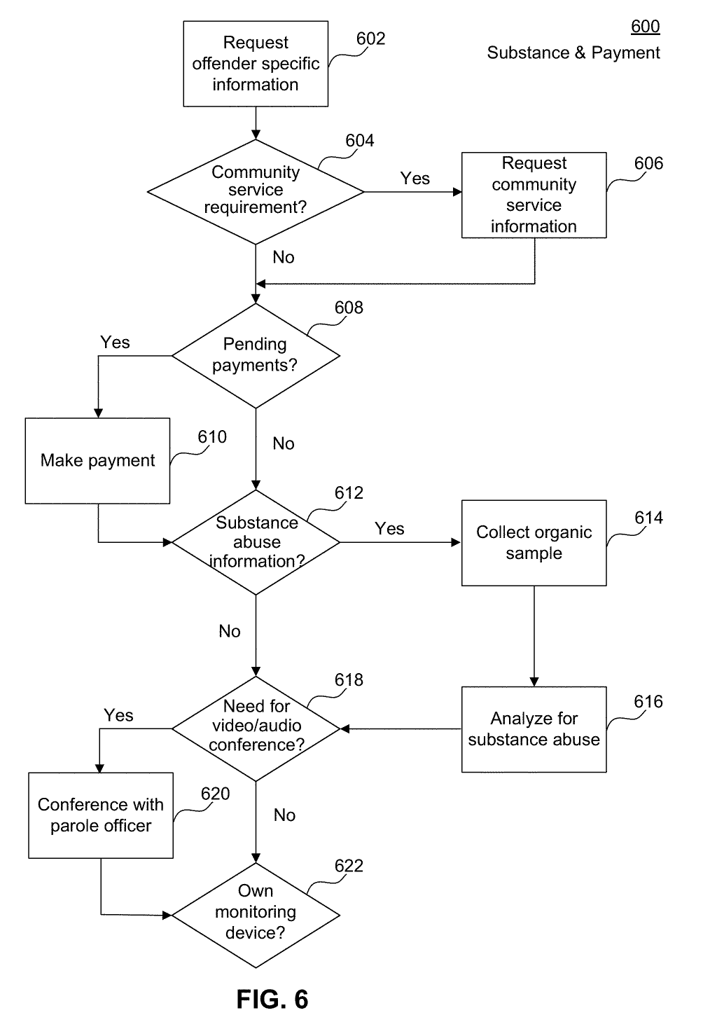

Based on the offender's parole information, the system next requests offender specific information (512/602). This step is described in detail in FIG. 6.

FIG. 6. illustrates a flowchart diagram of a method 600 for automated reporting procedure in regards to offender case specific information. The method of FIG. 6 is described below with reference to FIGS. 2 and 3.

The system determines whether the offender has community service requirements (604). Community service requirements may be a set number of community service hours of work performed per day/week/month, monthly reports of community service progress, and adherence to special program placements as ordered. If the system finds that the offender has community service requirements, the offender is required to submit information regarding the fulfillment of the requirements (606).

The system next determines whether the offender has pending payments to be made (608). The pending payments may include administrative fees, restitution for victims, among others. If the system finds pending payments for the offender (608—Y), the offender is prompted to make any payments that are due (610).

If there are no pending payments for the offender (608—N), the system determines whether the offender is under substance abuse monitoring (612). If the system determines that the offender is under substance abuse monitoring (612—Y), the system collects biological specimen from the offender (614). The biological specimen is collected through the sample analysis 332 of the kiosk 310. The sample analysis 332 of the kiosk may take the form of a breathalyzer, urine depository, hair depository, sweat pad depository, among others. Upon receipt of the biological specimen from the offender, the substance abuse monitoring subsystem 342 performs technical analysis of the biological specimen and conducts a screening test for substance abuse (616).

If there is no substance abuse monitoring requirement for the offender (612—N), the system makes a determination whether there is a need for video or audio conference between the offender and the parole office (618) based on any of the steps 602-616. If the system determines that the offender has violated a court order or any of the conditions of parole or probation (618—Y), a conference with the parole officer is initiated (620).

Once it is determined that there is no need for a video or audio conference between the offender and the parole office (618—N), the system determines whether the offender owns a remote monitoring device (514/622). If the offender owns a remote monitoring device (514/622—Y), then the system extracts monitoring information from the remote monitoring device (516). The monitoring device data extraction subsystem 344 establishes a connection with the remote monitoring device and extracts all location information contained in the remote monitoring device. The information may include GPS location information, photos, records, and voice samples, among others.

If the system determines that the offender does not own a remote monitoring device (514/622—N), the system receives monitoring information directly from the offender (518). For example, the offender may be asked whether he or she stayed within the restricted locations according to the parole conditions. Based on the monitoring information from either the extracted information from the remote monitoring device or the monitoring information received from the offender, the system makes a determination whether there is a need for a video or audio conference between the offender and the parole office (520). If the system determines that the offender has violated a court order or any of the conditions of parole or probation (520—Y), a conference with the parole officer is initiated (522).

Once it is determined that there is no need for a video or audio conference between the offender and the parole office (520—N), the system allows the offender to schedule the next automated report (524). For the scheduling step, an appointment calendar shows on the monitor 318 showing a 5 day span for the next reporting session. After a day is selected by the offender, the available time slots of the selected day is displayed. The schedule information for the offender is saved in the scheduling database 366 and later transmitted to the APPCS 210 to update the parolee database 230. Once the offender schedules the next report session, the reporting process is concluded (526) and the printer 328 prints a receipt with a summary of the automated report process, a receipt for any payments made, and the next appointment date and time.

### Exemplary Computer System Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

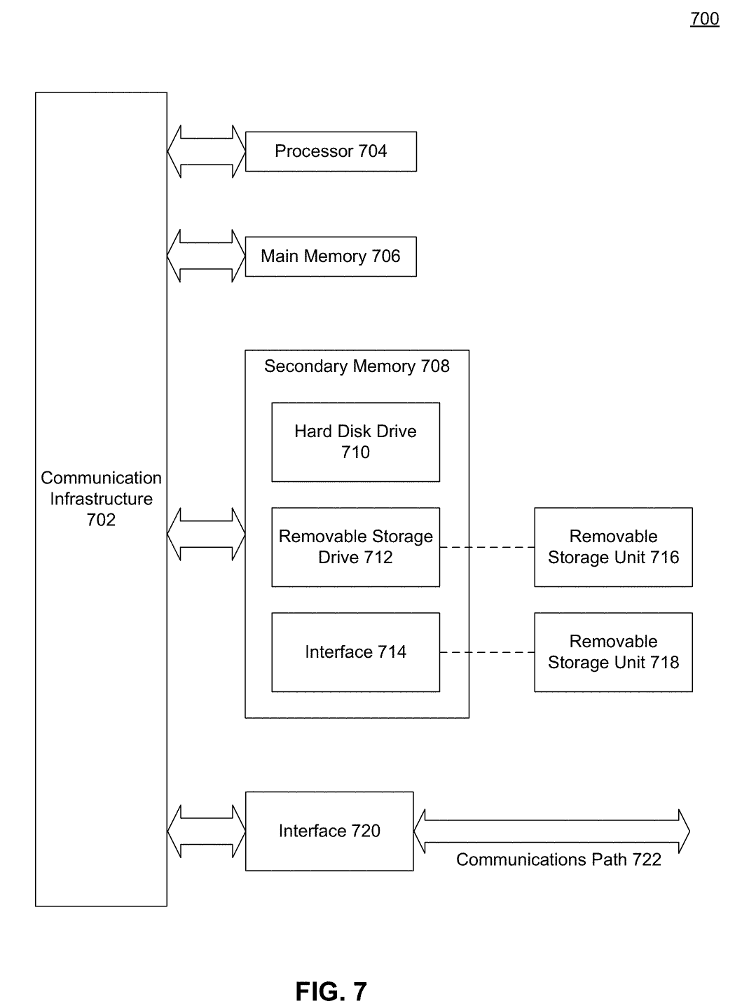

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, the method of flowcharts 400, 500, and 600 can be implemented in the environment of one or more computer systems or other processing systems. An example of such a computer system 700 is shown in FIG. 7. One or more of the modules depicted in the previous figures can be at least partially implemented on one or more distinct computer systems 700.

Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure.

What is claimed is:

1. A monitoring system for allowing an offender to make an automated report to a supervising officer, the monitoring system comprising:
a database that stores identifying information of the offender;
an authentication and verification subsystem configured to:
capture biometric information of the offender; and
compare the captured biometric information of the offender to biometric information of the offender stored in the database;
authenticate the offender to make the automated report based on the comparison;
a remote monitoring subsystem configured to:
receive location information from the offender;
generate data points based on the location information; and
compare the data points of the offender to a geographic limitations map of the offender stored in the database;
a substance abuse confirmation subsystem configured to:
receive biological specimen from the offender;
analyze the biological specimen to detect substance abuse;
confirm the analysis of the biological specimen; and
compare the analysis of the biological specimen to the biological information of the offender stored in the database; and
a report monitoring subsystem configured to:
detect a parole condition violation for the reporting offender based on the comparisons; and
take remedial action upon detection of the parole condition violation.

2. The monitoring system of claim 1, wherein the remote monitoring subsystem is further configured to receive the location information when transmitted by the offender via a predetermined wireless network.

3. The monitoring system of claim 1, wherein the remote monitoring subsystem is further configured to detect a data point of the offender outside of the geographic limitations map of the offender.

4. The monitoring system of claim 1, wherein the remote monitoring subsystem is further configured to take remedial action upon detection of the data point of the offender outside of the geographic limitations map of the offender.

5. The monitoring system of claim 1, wherein the substance abuse confirmation subsystem is further configured to:
determine DNA of the received biological specimen; and
compare the DNA of the received biological specimen to the DNA of the offender stored in the database.

6. The monitoring system of claim 1, wherein the remedial action includes alerting the supervising officer.

7. The monitoring system of claim 6, wherein the remedial action includes initiating a video conference between the offender and the supervising officer.

8. The monitoring system of claim 1, further comprising a report recording database that stores a recording of the automated report.

9. A monitoring system for allowing an offender to make an automated report to a supervising officer, the monitoring system comprising:
a database that stores identifying information of the offender;
an enrollment subsystem configured to enroll a reporting offender to the monitoring system;
an authentication subsystem configured to receive identifying information from a purported reporting offender, and to authenticate the purported reporting offender as the reporting offender based on the received identifying information;
a report subsystem configured to retrieve monitoring information from the reporting offender, wherein the monitoring information contains information based on parole conditions of the reporting offender;
a report monitoring system configured to detect a parole condition violation for the reporting offender by comparing the retrieved monitoring information to the parole conditions of the reporting offender stored in the database; and
a report scheduling subsystem configured to provide available report slots to the reporting offender, and to receive a report slot selection from the reporting offender.

10. The monitoring system of claim 9, wherein the enrollment subsystem is further configured to receive a personal identification number of the reporting offender and capture biometric identification information of the reporting offender.

11. The monitoring system of claim 10, wherein the enrollment subsystem is further configured to store the captured biometric identification information in the database in association with the personal identification number.

12. The monitoring system of claim 9, wherein the authentication and verification subsystem is further configured to:
receive the personal identification number of the offender; and
compare the received personal identification number the stored personal identification number.

13. The monitoring system of claim 12, wherein the authentication and verification subsystem is further configured to
identify the stored biometric identification information based on the comparison;
receive biometric information of the purported reporting offender; and
correlate the received biometric information to the stored biometric identification information.

14. The monitoring system of claim 13, wherein the authentication is configured to succeed or fail based on the correlating.

15. The monitoring system of claim 9, wherein the retrieved monitoring information includes substance abuse information, community service information, and geographical location information.

16. The monitoring system of claim 9, wherein the report monitoring system is further configured to take remedial action upon detection of the parole condition violation.

17. A monitoring method for making an automated report by an offender to a supervising officer, the monitoring method comprising:
authenticating a purported reporting offender as the reporting offender;
retrieving monitoring information from the reporting offender, wherein the monitoring information contains information based on parole conditions of the reporting offender;
detecting a parole condition violation of the reporting offender based on the monitoring information;
generating a schedule of availability that includes a plurality of available reporting slots;
providing the schedule of availability to the reporting offender; and
receiving an available reporting slot selection from the reporting offender.

18. The method of claim 17, wherein the authenticating includes comparing an identification number of the purported reporting offender to a stored identification number of the reporting offender, and comparing biometric information of the purported reporting offender to stored biometric information of the reporting offender.

19. The method of claim 17, wherein the generating of the schedule of availability is based on the frequency and regularity of reports required for the reporting offender based on parole conditions.

20. The method of claim 17, further comprising updating the report schedule for the reporting offender and taking remedial action upon failure to report at the scheduled time.
